(19) United States
(12) Patent Application Publication
(10) Pub. No.: US 2009/0063413 A1
(43) Pub. Date: Mar. 5, 2009

(54) METHOD AND SYSTEM FOR TRACKING ALLOCATIONS OF ASSETS AND TASKS

(75) Inventors: Hyung LEE, Clifton, VA (US); Dan CARR, Glenwood, MD (US)

Correspondence Address: H.C. PARK & ASSOCIATES, PLC, 8500 LEESBURG PIKE, SUITE 7500, VIENNA, VA, 22182, US

(73) Assignee: HANDYSOFT GLOBAL CORPORATION, Vienna, VA (US)

(21) Appl. No.: 11/848,999

(22) Filed: Aug. 31, 2007

(51) Int. Cl. G06F 7/06; G06F 17/30

(52) U.S. Cl. 707/3; 707/100; 707/104.1; 707/E17.108

(57) ABSTRACT

The present invention discloses a system for supporting task assignment and monitoring allocations of assets and tasks, including a data store and an audit trail generator. The data store stores information relating to assignments of sub-tasks of a task, and the audit trail generator provides an audit trail of the assignments, the sub-tasks, and the task and tracks action relating to the task during the life of the task. The present invention also discloses a method for tracking allocations of assets and tasks, including defining a task comprising sub-tasks, assigning each sub-task to a first assignee, and maintaining an audit trail by retrieving information relating to the progress of the task. The audit trail provides a single view of all the sub-tasks and all of the corresponding assignees during the life of the task.

### BACKGROUND OF THE INVENTION

1. Field of the Invention

The present invention relates to a method and a system for tracking allocations of assets and tasks.

2. Discussion of the Background

There are currently a number of BPM solutions that allow organizations to define, automate, and institutionalize structured business processes. However, the majority of work performed by organizations today is dynamic, rather than structured.

Dynamic work is largely facilitated through the use of email. For example, a high-level employee in an organization may use email to assign a task to a mid-level employee in the organization. The mid-level employee may then divide the task into sub-tasks and assign the work to other employees having the appropriate skills to complete the sub-tasks. However, email is not capable of monitoring work in real time, identifying issues relating to the task and sub-tasks as they unfold, or taking corrective action. Email also fails to provide an adequate audit trail of activities associated with fulfilling a task.

As a result, tasking solutions have been developed that enable users to assign work to others and track completion of the work. However, these tasking solutions provide only for peer-to-peer tasking. Therefore, if a first person is assigned a task and then divides that task into sub-tasks and reassigns the sub-tasks, the original assigner of the task may not be able to track the sub-tasks.

Therefore, a solution that models and displays work relating to a task in real time and a user-friendly format, which also enables the tracking of sub-tasks within a task, became necessary.

### SUMMARY OF THE INVENTION

This invention provides a system for supporting task assignment and monitoring allocations of assets and tasks.

This invention also provides a method for tracking allocations of assets and tasks.

Additional features of the invention will be set forth in the description which follows, and in part will be apparent from the description, or may be learned by practice of the invention.

The present invention discloses a system for supporting task assignment and monitoring allocations of assets and tasks, including a data store and an audit trail generator. The data store unit stores information relating to assignments of sub-tasks of a task, and the audit trail generator provides an audit trail of the assignments, the sub-tasks, and the task and tracks action relating to the task during the life of the task.

The present invention also discloses a method for tracking allocations of assets and tasks, including defining a task comprising sub-tasks, assigning each sub-task to a first assignee, and maintaining an audit trail by retrieving information relating to the progress of the task. The audit trail provides a single view of all the sub-tasks and all of the corresponding assignees during the life of the task.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a system for supporting task assignment and monitoring allocations of assets and tasks according to an exemplary embodiment of the present invention.

FIG. 2 shows a method for tracking allocations of tasks according to an exemplary embodiment of the present invention.

FIG. 3 is a detailed flowchart showing the function of a system according to an exemplary embodiment of the present invention.

FIG. 4 is an exemplary screen shot.

FIG. 5 shows exemplary screen shots of the task information and subtask information.

FIG. 6 show an exemplary screen shot of search results for assignees.

FIG. 7 shows an exemplary screenshot showing task status.

FIG. 8 shows exemplary screen shot of the grid format and spreadsheet.

FIG. 9 shows an exemplary screen shot of the visual graphic report.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art.

It will be understood that the system and methods of the invention may be used by any group to monitor task allocations. In other words, the invention is not limited to commercial, government, private sector, education, or personal use, and it may be used by groups of any size.

The HandySoft OfficeEngine User Guide, Version 1.0 is hereby incorporated by reference in this application for all purposes as if fully set forth herein.

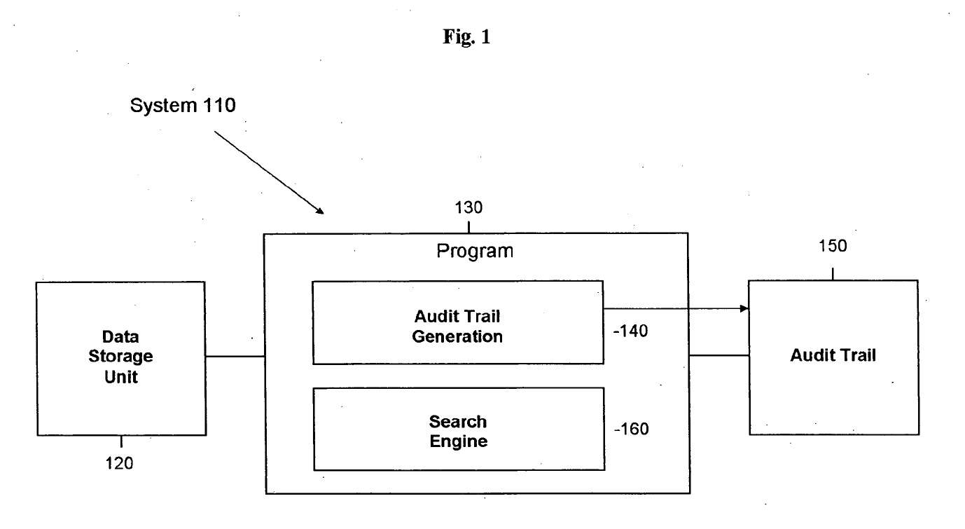

FIG. 1 shows a system for supporting task assignment and monitoring allocations of assets and tasks according to an exemplary embodiment of the present invention. Referring to FIG. 1, the system 110 includes a data storage unit 120 and a program 130 including an audit trail generator 140. The audit trail generator generates an audit trail 150.

The system 110 is built on a business process management (BPM) framework. The data storage unit 120 of the system 110 stores information of an organization. The information may include employee profiles, tasks and assignments, deadlines, the organization's content management system, the organization's knowledge management system, emails sent and received by employees, etc. The audit trail generator 140 generates an audit trail 150 using information from the data storage unit 120.

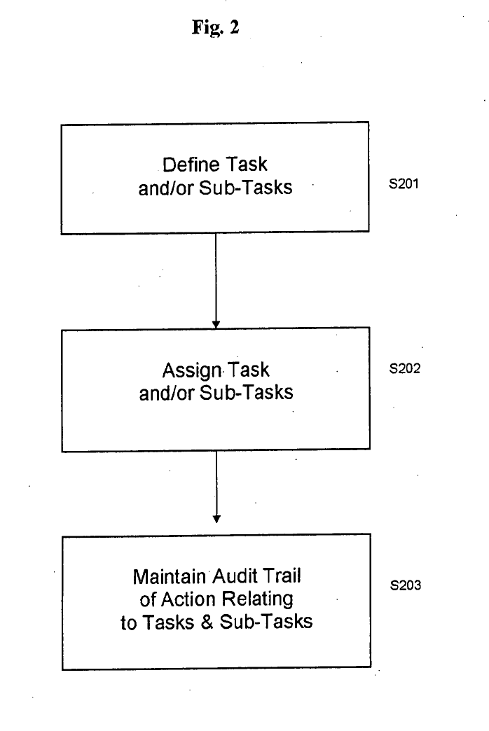

FIG. 2 shows a method of tracking allocations of tasks according to an exemplary embodiment of the present invention. First, referring to FIG. 2, a task is defined (S201).

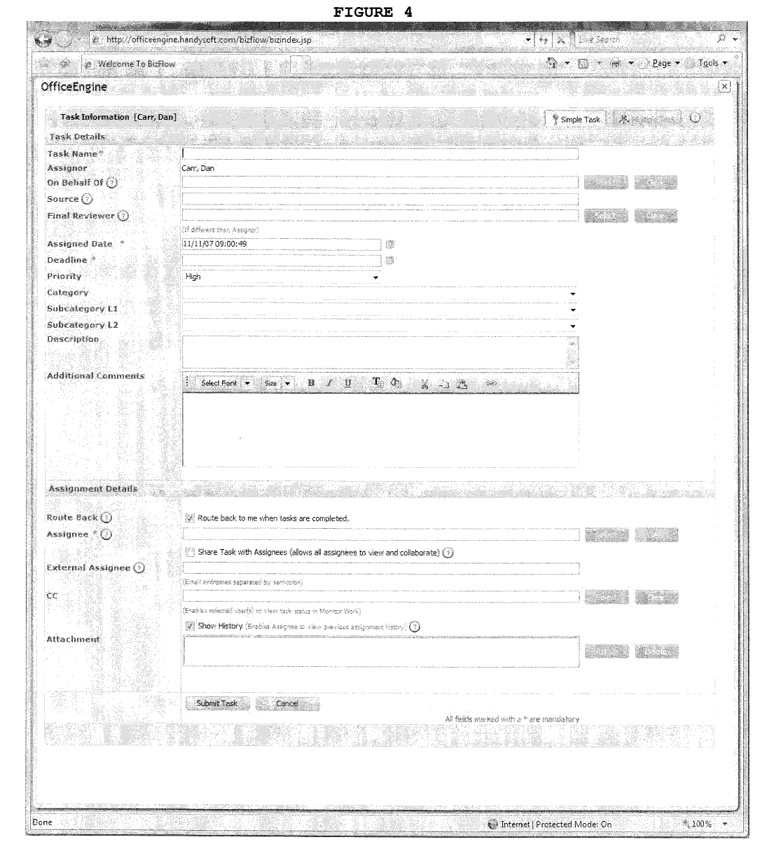

The Originator chooses a name for the task and sets one or more deadlines for the task. The Originator may also designate a Final Reviewer, choose a priority level (i.e. high, medium, or low), and categorize the task. A Description Field is provided for the task. The Description field may be limited to 2000 characters or any length appropriate to describe the task. Additionally, there is an Additional Comments field, which also may be limited to 2000 characters, where the Originator may include any additional information deemed necessary. Exemplary screen shot is shown in FIG. 4.

The task may be a Simple Task, which usually corresponds with a single task designated to one recipient, or a Multiple Task, which involves many tasks of different or similar nature being assigned to multiple recipients. Regardless of task type (Simple vs. Multiple) the recipient of a task can utilize the program to automatically create sub-tasks. Alternatively, the Originator of a task may manually enter information for each sub-task. The Originator may define each sub-task to be associated with the parent task. As long as a parent task is still active, meaning task originator has not completed the parent task, additional sub-tasks may be added to the task at a later time if so needed. Future additional assignees can be added to a sub-task as long as the sub-task is not completed.

Deadlines are tracked for every task, and tracked separately as a component of the program. The recipient of a task may request a deadline extension which must be approved by the task assignor. The deadlines extension requires identification of a new deadline, as well as a reason for requesting the deadline extension. The deadline request may be approved or rejected by the assigner of task. All deadline extension information is tracked in the history of the task.

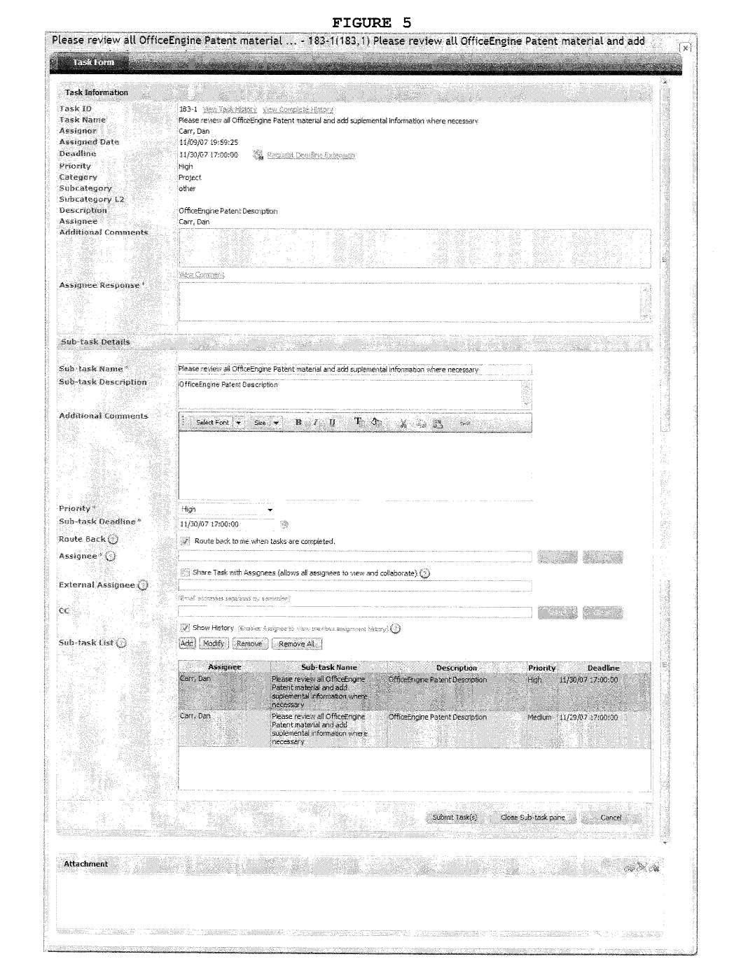

The Originator may choose a name for each sub-task or the program may automatically name the sub-tasks. As with the parent task, the Originator may designate a priority level (i.e. high, medium, or low) for each sub-task and categorize the sub-tasks. Also like the parent task, each sub-task includes a Description field and an Additional Comments field, in which the Originator may enter information specific to the corresponding sub-task. FIG. 5 shows exemplary screen shots of the task information and subtask information.

Once the parent task and sub-tasks, if any, have been defined, the task and/or sub-tasks are assigned (S202). The program 130 displays an Assignee field, which may include a pop-up list of people in the Originator's organization. The task must be assigned to at least one person, but may be assigned to multiple people. The task may also be assigned to a group of individuals constituting a user group, department, or any variation of an organizational unit.

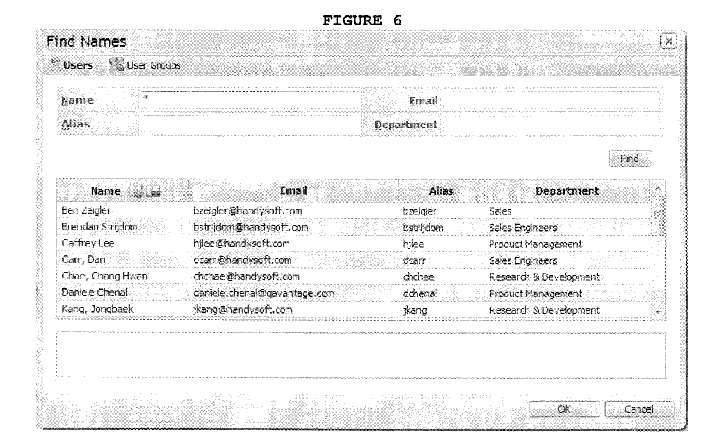

The Originator may manually enter the names of the Assignees selected or may choose them from the pop-up list. Alternatively, the Originator may enter a few letters of an Assignee's name and use a “Search” function to pull matching names from the data storage unit 120. The Originator may then select the name of the desired Assignee from the matching names returned. The data storage unit 120 may further provide the email address, alias, phone number, department, and any other information for each Assignee. FIG. 6 show an exemplary screen shot of search results for assignees.

If a task or sub-task is to be assigned to a person outside of the organization, the Originator may enter the person's email address in an External Assignee field. An email assigning the task will be sent to the designated External Assignee. The Originator may receive an email when the External Assignee has completed the task. The Originator is responsible for updating the task response in order to complete the task in the system 110.

When tasks are assigned to Assignees, the Assignees may further divide the task into sub-tasks. Therefore, the program 130 provides for sub-tasks to be further divided into jobs, which are then assigned to other people within the organization. The jobs may then be further divided and assigned as needed. There is no limit to the number of task/sub-task assignments.

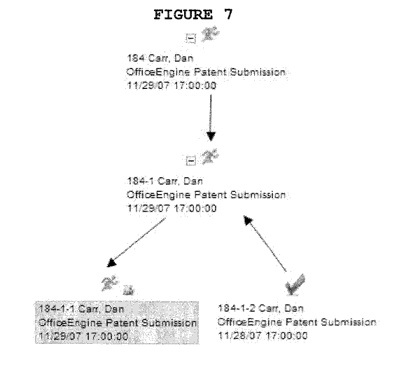

The Originator may send carbon copy emails to other people in the organization to notify them of the task, sub-task, and job assignments. The carbon copy feature allows an individual to observe the status of the specific task, including the completion and detail history of each task, sub-task, or job. The Show History function provides a view of the task, sub-task, or job from this point back to the beginning, including any parent task or sub-task it may belong to. Every action taken upon a task is captured in the Task History (deadline extensions, attachments, reject, approve, etc.) allowing an instant snapshot of the task status. FIG. 7 shows an exemplary screenshot showing task status.

Once the task and any sub-tasks and jobs have been assigned, an audit trail 150 of action relating to the task, sub-tasks, and jobs is maintained (S203). The audit trail 150 allows the Originator, or any person whom the Originator has granted access, to monitor the progression of the task, sub-tasks, and jobs. The audit trail generator 140 retrieves information relating to the task from the data storage unit 120 of the system 110 and provides a detailed, real-time audit trail 150 that includes information regarding who is involved in the task, how sub-tasks and jobs are moved forward, whether or not others have been assigned sub-tasks, which sub-tasks and jobs are completed, which sub-tasks and jobs are still pending, where a bottleneck might be happening, and whether or not the task is ultimately on track to meeting current deadlines.

The program 130 including the audit trail generator 140 may be implemented as a stand alone application using software modules that may be stored on a computer-readable medium and executed by a computer that is supported by the invention. For example, an Intel-based server with a Windows® Operating System may be used. However, as one of ordinary skill in the art would recognize, there are numerous operating systems (such as Windows®, MacOS®, Unix, Linux, etc.) and hardware architectures (such as PowerPC®, Sun Sparc®, etc.) that could be used.

Alternatively, the program 130 including the audit trail generator 140 may operate from within a variety of standard portals. It is possible for the audit trail generator 140 to be directly embedded in Microsoft Outlook® or other email network programs, which may decrease the time required for organizations to deploy the audit generator 140.

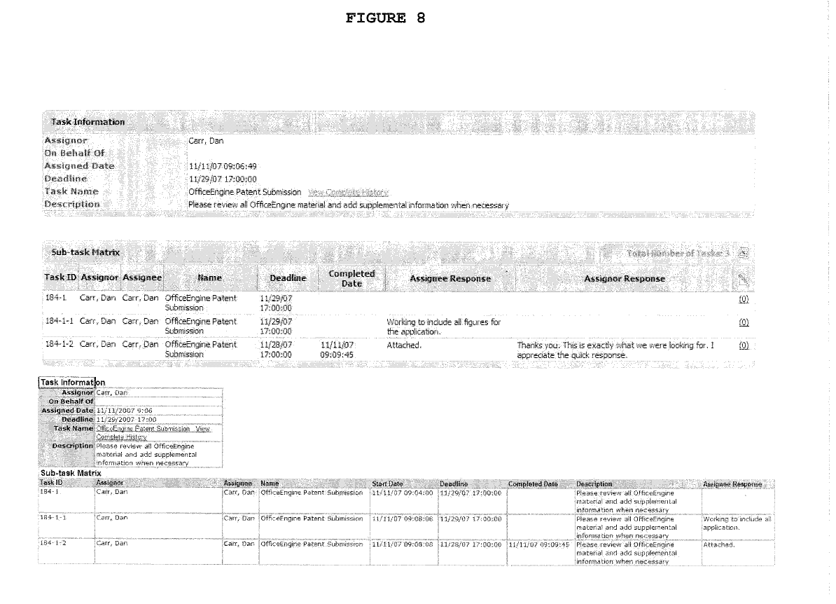

The audit trail 150 is displayed in a grid format so that the Originator may easily review the progression of the task. This grid may be exported into a Microsoft Excel® spreadsheet and may be saved or displayed in a Microsoft Excel® format. FIG. 8 shows exemplary screen shot of the grid format and spreadsheet.

As shown in FIG. 1, the audit trail 150 provides a single centralized view of the progression of the task. The view may include a flow chart showing the delegation of tasks and sub-tasks to individuals within and outside of the organization. Comments, including any requests or questions of Assignees, responses by the Originator or other Assignors, and any other relevant notes, may be included with each parent task, sub-task, and job. Additionally, all emails including any attachments and other forms of collaboration may be displayed or accessed from the audit trail 150. The audit trail 150 may further display a deadline for each task, sub-task, and job and any tasks, sub-tasks, and jobs that have been completed may be designated as such. As a result, the progression of a task may be easily and thoroughly tracked in real time.

The program 130 also may be capable of reassigning tasks, closing tasks, suspending tasks, resuming tasks, and escalating tasks by modifying due dates. As a result, the process of modifying a working model may be simplified. Additionally, all of the Assignees may be automatically emailed when a change occurs.

The program 130 may further provide a workspace displaying an assignment to a corresponding Assignee. This workspace may be exported to Microsoft Excel and saved. An Assignee working on a task, sub-task, or job may complete the work and send a response to the Originator or corresponding Assignor through the workspace. An Assignee may also use the workspace to view or add comments, divide an assignment into multiple assignments that are then reassigned, save work that has been done on the assignment, attach or retrieve a file, and view the assignment's history. Additionally, an Assignee may request more information or an extended deadline from the Originator or corresponding Assignor through the workspace. The program allows task recipients to interact with the task assigner, or task assignee by adding external comments to each task. In this manner, the task does not need to be physically viewed in order to see the external comments.

The program 130 may further include a search engine 160. The search engine 160 may have intelligent searching capabilities. For instance, the search engine may interpret an individual assignment and proactively locate and provide a ranked list of information assets to the corresponding Assignee. The information may include desktop documents, documents from the corporate content management system, relevant emails, Internet references, etc. For example, if an Assignee's job was to “Provide recommendations for a new and improved order entry application, including pricing, to help us manage our customer orders better,” the search engine 160 might provide the Assignee's historical emails that make mention of order entry applications, the contract that the Assignee's organization signed two years ago with their original order entry application vendor from the organization's content management system, and industry analyst reports from the Internet that list the organization's top ten order entry applications.

Once Assignees complete their assignments, their responses work their way back up the chain through any intermediate Assignors to the Originator. Each intermediate Assignor may either approve a response or request rework of the assignment. When an Assignor requests rework, the assignment passes back down the chain to the Assignee. On the other hand, when all intermediate Assignors corresponding to an assignment approve a response, the response is sent to the Originator. The Originator then may approve the parent task and archive the results or request rework.

The program 130 also provides for completed tasks to be archived in the system 110. The program 130 may search these archived files in the future to aid an Originator in assigning a new task. For example, the program may identify past tasks that are the most similar to tasks an Originator is currently trying to assign and thereby provide insights and knowledge as how similar tasks were created and executed in the past.

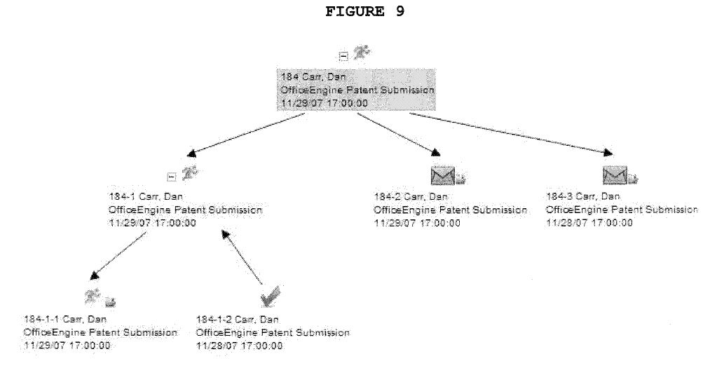

Reports may be generated by the program 130 to show a snapshot of a specific task activity. The reports may be in the form of a visual graph showing how many running sub-tasks currently exist. This graph may be color coded to designate sub-tasks that overdue, sub-tasks that are currently due, and sub-tasks that are due in the near future (i.e. within 1-2 days). Alternatively, the graph may designate all tasks assigned in the previous year, month, or week or tasks assigned to a single individual in the previous year, month, or week. FIG. 9 shows an exemplary screen shot of the visual graphic report.

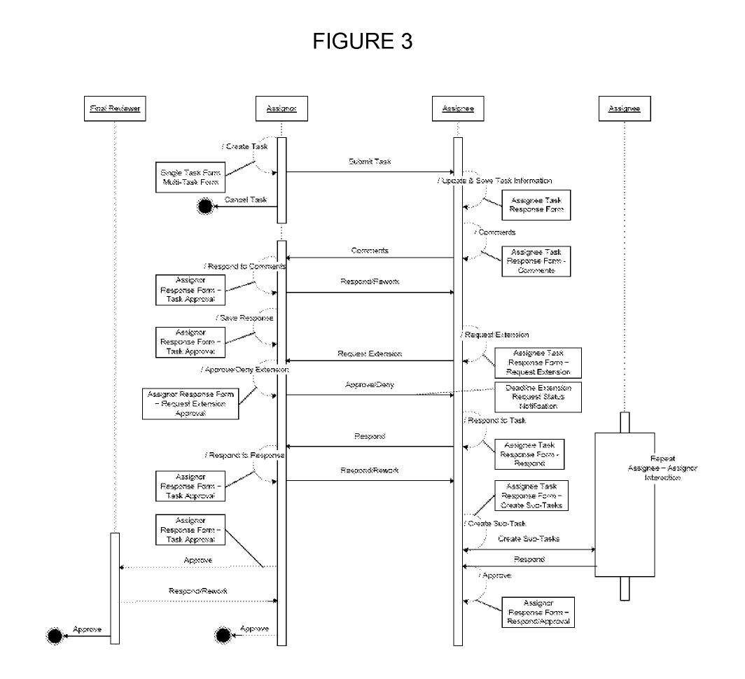

FIG. 3 is a detailed flowchart showing the function of a system according to an exemplary embodiment of the present invention.

First, an Assignor creates a task (S301), which may have a Single Task form or a Multi-Task form. Then the Assignor submits the task (S302) to an Assignee who may update and save the task information using an Assignee Task Response Form (S303). The Assignor may also cancel a task after the task has been created.

Once an Assignee has been given a task, the Assignee begins work on the task and may send comments to the Assignor (S304) using an Assignee Task Response Form-Comments. Sending comments from the Assignee to the Assignor may provide the Assignor with an action request to provide additional information. Comments may be used to obtain a better understanding of the task, and to share knowledge of the task between the Assignor and Assignee. The Assignor may respond to the Assignee's comments or request rework of the completed work by sending an Assignor Response Form-Task Approval to the Assignee (S305). The Assignor Response Form-Task Approval is saved to the Assignor's workspace.

The Assignee may request an extension for completing an assigned task by sending an Assignee Response Form-Request Extension to the Assignor (S306). The Assignor may then approve or deny the request for an extension using an Assignor Response Form-Task Approval (S307). Once the Assignor has decided to approve or deny the request for an extension, a notification of the approval or denial may be sent to the Assignee, such as by email, as a Deadline Extension Request Status Notification.

Once the task has been completed, the Assignee may respond to the Assignor using an Assignee Response Form-Respond (S308). The Assignor may then respond to the Assignee or request rework by sending an Assignor Response Form-Task Approval to the Assignee (S309). If the Assignor approves the completed task received from the Assignee in step S308, the Assignor may then send the task to a Final Reviewer (S310) for review. The Final Reviewer may then approve the task (S311) or respond to the Assignor with comments or a request for rework (S312). Additionally, if the task is a sub-task of a parent task, the task may be incorporated into the parent task. If the task is a parent task, it may be stored for review depending upon permission settings associated with the task. This may occur upon approval by the Assignor of the task.

If the Final Reviewer responds with comments to or requests rework from the Assignor, the Assignor may again send an Assignor Response Form-Task Approval to the Assignee (S309). This cycle may continue until the Final Reviewer approves the task (S311) or upon some other contingency incorporated into the task at creation (S301) or at a later stage of the task. Additionally, upon approval by the Final Reviewer of the task, a task may be incorporated into a parent task, or may be stored for review depending upon permission settings associated with the task.

When the Assignee receives a task, the Assignee may also create a sub-task using an Assignee Response Form-Create Sub-Tasks (S313). The Assignee may then submit the sub-task to a second Assignee (S314). The Assignee and the second Assignee may interact with one another in the same way described above with respect to the Assignor and the Assignee. Once the second Assignee has sent the completed the sub-task to the Assignee (S315), the Assignee may approve the sub-task using an Assignor Response Form-Respond Approval (S316).

The method shown in FIG. 3 is performed using the program 130 described with respect to FIG. 1. The Assignor and the Assignee may track the task and sub-task, respectively, using the audit trail 150 generated by the audit trail generator 140 of the program 150. Additionally, the Assignor and Assignee may use the program 130 to generate reports showing snapshots of specific task activities.

As discussed above, the present invention models and displays work in real time in a single, centralized audit trail that details the journey of all work items related to a task. This provides for tracking of the individuals involved in the task, as well as all collaboration, attachments, and related status information.

Also, the present invention may improve worker productivity through its search engine, which captures and interprets the business context of each task assigned, then searches internal and external information sources, and finally, displays documents, presentations, and content that may assist the Assignee in completing an assigned task.

As a result, the inventive system may reduce the time and cost to model an existing work process. Additionally, it may be possible to deploy the system quickly with minimal IT investment and end-user training.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents

What is claimed is:

1. A system for supporting task assignment and monitoring allocations of assets and tasks, comprising:
a data storage unit to store information relating to assignments of a task and sub-tasks of the task; and
an audit trail generator to provide an audit trail of the assignments, the sub-tasks, and the task;
wherein the audit trail generator tracks action relating to the task during the life of the task.

2. The system of claim 1, further comprising:
a search engine to automatically search data sources for information related to the task and sub-tasks.

3. The system of claim 2, wherein the data sources comprise electronic files, emails, and the internet.

4. The system of claim 1, wherein the information in the data storage unit comprises assignments, completion dates and deadlines, collaboration efforts relating to sub-tasks, and all documents relating to the task.

5. The system of claim 1, wherein the information in the data storage unit is archived.

6. The system of claim 1, wherein the audit trail generator comprises a computer program encoded in a computer-readable medium.

7. The system of claim 1, wherein the audit trail generator is built on an enterprise business process management (BPM) framework.

8. A method for tracking allocations of assets and tasks, comprising:
defining a task comprising sub-tasks;
assigning each sub-task to a first assignee; and
maintaining an audit trail by retrieving information relating to the progress of the task;
wherein the audit trail comprises a single view of all the sub-tasks and all of the corresponding assignees during the life of the task.

9. The method of claim 8, further comprising:
dividing a sub-task into multiple jobs; and
assigning each job to a second assignee.

10. The method of claim 8, further comprising:
searching data sources for information related to each sub-task and job,
wherein searching is performed automatically when an assignee is assigned a sub-task or a job.

11. The method of claim 10, wherein the data sources comprise electronic files, emails, and the internet.

12. The method of claim 8, wherein the retrieved information comprises assignments, completion dates and deadlines, collaboration efforts relating to sub-tasks, and all document files relating to the task.

13. The method of claim 8, further comprising:
archiving the retrieved information.

14. The method of claim 8, wherein the audit trail is generated a computer program encoded in a computer-readable medium.

15. An audit trail generator, comprising:
a computer program built on an enterprise business process management (BPM) framework,
wherein the computer program tracks action relating to a task and provides an audit trail comprising a single view of the task, the tracked action, and corresponding assignees.
